(19) United States
(12) Patent Application Publication
(10) Pub. No.: US 2006/0124914 A1
(43) Pub. Date: Jun. 15, 2006

(54) Baluster aligning apparatus and method

(76) Inventor: Albert L. Lavargna JR., Revere, MA (US)

Correspondence Address: SEAN KAUFHOLD, P. O. BOX 89626, SIOUX FALLS, SD, 57109, US

(21) Appl. No.: 11/005,373

(22) Filed: Dec. 6, 2004

(51) Int. Cl. E04H 17/14; B21D 47/00; B23Q 3/00

(52) U.S. Cl. 256/59; 29/464; 29/897.312

(57) ABSTRACT

A baluster aligning apparatus and method includes an elongated panel has a front side, a back side, a bottom edge, a top edge, a first lateral edge and a second lateral edge. Each of a pair of flanges is attached to and extends away from the front side of the panel. The flanges are positioned adjacent to and extend along one of the first and second lateral edges. The panel has fixed width equal to between 3 inches and 6 inches. A horizontal level is mounted in the panel. A first baluster is vertically aligned against the first lateral edge and then attached to top and bottom rails. A second baluster is vertically aligned against the second lateral edge and then attached to the top and bottom rails. This is repeated so that a plurality of equally spaced, vertically aligned balusters is formed.

### BACKGROUND OF THE INVENTION

1. Field of the Invention

The present invention relates to baluster aligning devices and more particularly pertains to a new baluster aligning device for aiding in the alignment and spacing of balusters.

2. Description of the Prior Art

The use of baluster aligning devices is known in the prior art. U.S. Pat. No. 6,173,503 describes a device that is adjustable for selectively choosing a distance for spacing spindles. A similar device is found in U.S. Pat. No. 5,163,233 which includes a coupler and a pair of outwardly extending arms for correctly spacing studs from each other. Devices for leveling are shown in U.S. Pat. Des. No. 244,837, and U.S. Pat. No. 5,408,752.

While these devices fulfill their respective, particular objectives and requirements, the need remains for a device that allows a person to both vertical align and equally space a plurality of balusters with respect to each other. The device should have a fixed configuration to reduce the chance for error and also include additional levels for alternating the angle of the balusters with respect to a handrail.

### SUMMARY OF THE INVENTION

The present invention meets the needs presented above by generally comprising an elongated panel has a front side, a back side, a bottom edge, a top edge, a first lateral edge and a second lateral edge. The first and second lateral edges are orientated parallel to each other. The panel has a fixed width from the first lateral edge to the second lateral edge that is generally equal to between 3 inches 6 inches. Each of a pair of flanges is attached to and extends away from the front side of the panel. The flanges are positioned adjacent to and extend along one of the first and second lateral edges. A distance from an outer edge of each of the flanges to the back side is generally equal to ½ inch. A horizontal level is mounted in the panel. The horizontal level measuring a level plane orientated perpendicular to a longitudinal axis of the panel. A first baluster is extended between top and bottom rails. The first lateral edge is positioned against the first baluster and the first baluster is attached to the top and bottom rails when the first baluster is vertically orientated. A second baluster is extended between the top and bottom rails. The second baluster is abutted against the second lateral edge so that the panel abuts each of the first and second balusters. The second baluster is attached to the top and bottom rails and the panel is removed from between the first and second balusters. The first lateral edge may be positioned against consecutive balusters and a next consecutive one of the balusters is abuttable against the second lateral edge so that a plurality of vertically aligned balusters are positioned for being attached to the top and bottom rails.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front view of a baluster aligning apparatus and method according to the present invention.

FIG. 2 is a perspective view of the present invention.

FIG. 3 is a cross-sectional view taken along line 3-3 of FIG. 2 of the present invention.

FIG. 4 is a perspective view of a second embodiment of the present invention.

### DESCRIPTION OF THE PREFERRED EMBODIMENT

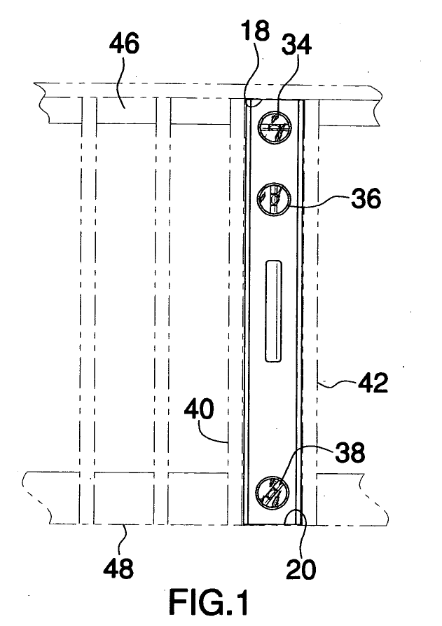

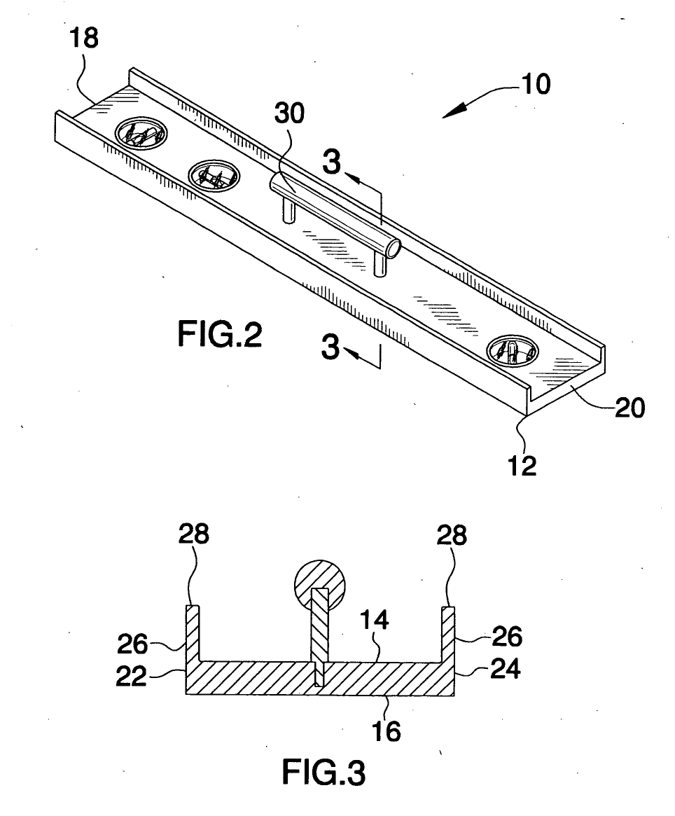

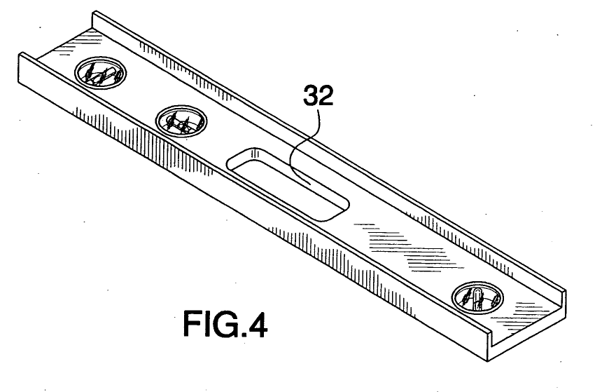

With reference now to the drawings, and in particular to FIGS. 1 through 4 thereof, a new baluster aligning device embodying the principles and concepts of the present invention and generally designated by the reference numeral 10 will be described.

As best illustrated in FIGS. 1 through 4, the baluster aligning apparatus and method 10 generally comprises providing an elongated panel 12 that has a front side 14, a back side 16, a bottom edge 18, a top edge 20, a first lateral edge 22 and a second lateral edge 24. The first 22 and second 24 lateral edges are orientated parallel to each other. The panel 12 has a fixed height from the bottom edge 18 to the top edge 20 generally equal to between 28 inches and 32 inches and more preferably between 29½ inches and 30½ inches. The panel has a fixed width from the first lateral edge 22 to the second lateral edge 24 generally equal to between 3 inches 6 inches, more preferably between 4 inches and 6 inches and more preferably between 4½ inches and 5½ inches. These measurements generally correspond to building code requirements. Each of a pair of flanges 26 is attached to and extends away from the front side 14 of the panel 12. The flanges 26 are each positioned adjacent to and extend along one of the first 22 and second 24 lateral edges. A distance from an outer edge 28 of each of the flanges 26 to the back side 16 is generally equal to ½ inch.

A handle 30 is attached to and extends away from the front side 14 of the panel 12. The handle 30 is positioned generally between the top 18 and bottom 20 edges. Alternatively, an aperture 32 extending through the panel 12 may define a handle as shown in FIG. 4.

A horizontal level 34 is mounted in the panel 12. The horizontal level 34 measures a level plane orientated perpendicular to a longitudinal axis of the panel 12. A vertical level 36 is mounted in the panel 12 and is adapted for measuring a level plane orientated parallel to the longitudinal axis of the panel 12. A 45 degree level 38 is mounted in the panel 12 and is adapted for measuring a level plane orientated 45 degrees to the longitudinal axis of the panel 12.

In use, a first baluster 40 of a plurality of balusters is extended between a top rail 46 and a bottom rail 48. The first lateral edge 22 is abutted against the first baluster 40 and the first baluster 40 is attached to the top 46 and bottom 48 rails when the first baluster 40 is vertically orientated. A second baluster 42 is extended between the top 46 and bottom 48 rails. The second baluster 42 is abutted against the second lateral edge 24 so that the panel 12 abuts each of the first 22 and second 24 balusters. The second baluster 24 is then attached to the top 46 and bottom 48 rails and the panel 12 is removed from between the first 40 and second 42 balusters. The flanges 26 help to keep the panel 12 on the balusters 40, 42 by extending the surface area of the first 22 and second 24 lateral edges without adding significant weight to the panel 12. This procedure may be continued wherein the first lateral edge 22 is positioned against consecutive ones of the balusters and a next consecutive one of the balusters is abuttable against the second lateral edge 24 so that a plurality of vertically aligned balusters are positioned for being attached to the top 46 and bottom rails 48. The fixed nature of the width of the panel ensures that the balusters are all equally spaced from each other and aligned parallel with respect to each other.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of mounting balusters between a top rail and a bottom rail comprising the steps of:
providing an elongated panel having a front side, a back side, a bottom edge, a top edge, a first lateral edge and a second lateral edge, said first and second lateral edges being orientated parallel to each other, said panel having a fixed width from said first lateral edge to said second lateral edge generally equal to between 3 inches 6 inches, each of a pair of flanges is attached to and extends away from said front side of said panel, each of said flanges being positioned adjacent to and extending along one of said first and second lateral edges, a distance from an outer edge of each of said flanges to said back side being generally equal to ½ inch;
providing a horizontal level being mounted in said panel, said horizontal level measuring a level plane orientated perpendicular to a longitudinal axis of said panel;
extending a first baluster of said balusters between the top and bottom rails;
positioning said first lateral edge against said first baluster and attaching said first baluster to said top and bottom rails when said first baluster is vertically orientated;
extending a second baluster of said balusters between the top and bottom rails;
abutting said second baluster against said second lateral edge such that said panel abuts each of said first and second balusters, attaching said second baluster to said top and bottom rails and removing said panel from between said first and second balusters; and
wherein said first lateral edge may be positioned against consecutive ones of said balusters and a next consecutive one of said balusters is abuttable against said second lateral edge such that a plurality of vertically aligned balusters are positioned for being attached to said top and bottom rails.

2. The method according to claim 1, wherein said panel has a height from said bottom edge to said top edge generally between 28 inches and 32 inches.

3. The method according to claim 1, further providing a handle being attached to and extending away from said front side of said panel.

4. The method according to claim 1, wherein said panel has an aperture extending therethrough, said aperture defining a handgrip.

5. The method according to claim 1, further providing a vertical level being mounted in said panel, said vertical level being adapted for measuring a level plane orientated parallel to said longitudinal axis of said panel.

6. The method according to claim 1, further providing a 45 degree level being mounted in said panel, said vertical level being adapted for measuring a level plane orientated 45 degrees to said longitudinal axis of said panel.

7. The method according to claim 1, wherein said panel has a width generally between 4 inches and 6 inches.

8. The method according to claim 1, wherein said panel has a width generally between 4½ inches and 5½ inches.

9. The method according to claim 8, wherein said panel has a height generally between 29½ inches and 30½ inches.

10. A method of mounting balusters between a top rail and a bottom rail comprising the steps of:
providing an elongated panel having a front side, a back side, a bottom edge, a top edge, a first lateral edge and a second lateral edge, said first and second lateral edges being orientated parallel to each other, said panel having a fixed height from said bottom edge to said top edge generally equal to between 28 inches and 32 inches, said panel having a fixed width from said first lateral edge to said second lateral edge generally equal to between 3 inches 6 inches, each of a pair of flanges being attached to and extending away from said front side of said panel, each of said flanges being positioned adjacent to and extending along one of said first and second lateral edges, a distance from an outer edge of each of said flanges to said back side being generally equal to ½ inch;
providing a handle being attached to and extending away from said front side of said panel, said handle being positioned generally between said top and bottom edges;
providing a horizontal level being mounted in said panel, said horizontal level measuring a level plane orientated perpendicular to a longitudinal axis of said panel;
providing a vertical level being mounted in said panel, said vertical level being adapted for measuring a level plane orientated parallel to said longitudinal axis of said panel;
providing a 45 degree level being mounted in said panel, said vertical level being adapted for measuring a level plane orientated 45 degrees to said longitudinal axis of said panel;
extending a first baluster of said balusters between the top and bottom rails;
positioning said first lateral edge against said first baluster and attaching said first baluster to said top and bottom rails when said first baluster is vertically orientated;
extending a second baluster of said balusters between the top and bottom rails;
abutting said second baluster against said second lateral edge such that said panel abuts each of said first and second balusters, attaching said second baluster to said top and bottom rails and removing said panel from between said first and second balusters; and
wherein said first lateral edge may be positioned against consecutive ones of said balusters and a next consecutive one of said balusters is abuttable against said second lateral edge such that a plurality of vertically aligned balusters are positioned for being attached to said top and bottom rails.
